(19) United States
(12) Patent Application Publication
(10) Pub. No.: US 2026/0366949 A1
(43) Pub. Date: Nov. 19, 2026

(54) CONTROLLING OPERATIONS OF TESTING DEVICES FOR PERFORMING AIR LEAKAGE TEST

(71) Applicant: Aeroseal LLC, Miamisburg, OH (US)

(72) Inventor: Ethan Shepherd, Dayton, OH (US)

(21) Appl. No.: 19/210,114

(22) Filed: May 16, 2025

(51) Int. Cl. G01M 3/28

(52) U.S. Cl. CPC G01M 3/2846

(57) ABSTRACT

The present disclosure discloses a system for controlling an operation of a testing device for performing an air leakage test. The system transmits a first predefined control signal to the testing device. The system causes the testing device to effect a continual increase in a volume of a fluid flowing into a flexible tubing until a termination condition is met. The system receives pressure data associated with each of the flexible tubing and an enclosure. The system compares the pressure data to a predefined target pressure value. The system generates a second control signal for a controller for controlling the testing device. The system controls, using the controller, the operation of the testing device to cause an increase in the pressure within the enclosure to reach the predefined target pressure value based on the second control signal.

### TECHNICAL FIELD

The present disclosure generally relates to control systems and more particularly relates to controllers, systems and methods for controlling operations of a testing device for performing an air leakage test.

### BACKGROUND

Air leakage testing is a critical process for evaluating the energy efficiency and structural integrity of the building's envelope. The primary objective of an air leakage test is to accurately measure a rate of air infiltration and exfiltration, an indoor air quality, and an overall building performance. By identifying and quantifying areas where unwanted air infiltration and exfiltration occur, air leakage testing enables to implement targeted improvements in insulation, sealing, and overall construction quality.

Air leakage testing involves creating a controlled pressure difference between an interior and an exterior of a building. Generally, a testing device, such as a blower or a fan is used to achieve this pressure difference. In this manner, it allows for the precise measurement of air leakage rates. The accuracy and reliability of the air leakage test is highly dependent on the ability to control an operation of the testing device with precision. In certain cases, precise control of the testing device may also be required during a sealing process of identified air leakages in the building envelope. To this end, the building envelope may have a predefined maximum safe pressure of operation of the testing device that needs to be observed to avoid damage.

However, the testing device may be controlled by using, for example, manual adjustments or rudimentary automated systems that may not provide the necessary level of precision and adaptability for different testing conditions and/or maintain pressure within the predefined maximum safe pressure. These methods can be time-consuming, inconsistent, and may not seamlessly integrate with modern data acquisition and analysis systems. Moreover, in certain cases, testing devices operating at higher pressure than the predefined maximum safe pressure may cause physical damage(s) within the building envelope.

Therefore, there is a need for a controller to precisely control an operation of the testing device to achieve desired and safe operating pressure within the envelope for precise testing and/or sealing while preventing any physical damage.

### SUMMARY

The present disclosure provides a system, a method and a computer programmable product for controlling an operation of a testing device for performing an air leakage test based on closed loop control settings.

In one aspect, a system for controlling an operation of a testing device for performing an air leakage test is provided. The system may include a memory configured to store computer executable instructions and one or more processors configured to execute the instructions to transmit a first predefined control signal to the testing device to initiate the operation thereof. The one or more processors are further configured to cause the testing device to effect a continual increase in a volume of the fluid flowing into a flexible tubing until a termination condition is met in response to the first predefined control signal. The termination condition is associated with reaching an inflated state of the flexible tubing from a deflated state. The testing device is in fluid connection with the flexible tubing. The one or more processors are further configured to receive pressure data associated with each of the flexible tubing and an enclosure. The pressure data is indicative of a pressure within each of the flexible tubing and the enclosure when the inflated state of the flexible tubing is reached. The enclosure is in fluid connection with the flexible tubing. The one or more processors are further configured to compare the received pressure data to a predefined target pressure value. The one or more processors are further configured to generate a second control signal for a controller for controlling the testing device, based on the comparison. The one or more processors are further configured control, using the controller, the operation of the testing device to cause an increase in the pressure within the enclosure to reach the predefined target pressure value based on the second control signal.

In an embodiment, the one or more processors are further configured to continuously receive updated pressure data associated with each of the flexible tubing and the enclosure. The one or more processors may be further configured to compare the received updated pressure data to the predefined target pressure value. The one or more processors may be further configured to determine whether a pressure within at least the enclosure is greater than the predetermined threshold value. The one or more processors may be further configured to control the operation of the testing device to maintain the predefined target pressure value within the enclosure using the controller.

In an embodiment, the testing device may be a fan operable to supply air pressurized air to each of the flexible tubing and the enclosure.

In an embodiment, the one or more processors are further configured to control, using the controller, a rotation speed of the fan in response to the second control signal, wherein the rotation speed is controlled to reach and maintain the predefined target pressure value of the fluid within at least the enclosure.

In an embodiment, the one or more processors are further configured to calculate a pressure difference based on the comparison between the received pressure data and the predefined target pressure value. The one or more processors may be further configured to generate the second control signal for the controller based on the pressure difference.

In an embodiment, the one or more processors are further configured to transmit, to the controller, the second control signal. The controller is connected to the testing device. The one or more processors are further configured to control, using the controller, the operation of the testing device to reach and maintain the predefined target pressure value of the fluid within at least the enclosure.

In an embodiment, the controller is at least one of: a proportional (P) controller, an integral (I) controller, a derivative (D) controller, a PI controller, a PD controller, a PID controller, a fuzzy logic controller, an on-off controller, an adaptive controller, a model predictive controller, or a sliding mode controller.

In an embodiment, the pressure data may be received from one or more pressure sensors arranged in connection with each of the flexible tubing and the enclosure.

In an embodiment, the one or more pressure sensors may include at least a manometer.

In an embodiment, the one or more processors are further configured to obtain test data associated with the enclosure in response to controlling the operation of the testing device to maintain the predefined target pressure value within the enclosure. The test data comprises at least one of: pressure characteristics data associated with the enclosure, flow characteristics data associated with the enclosure, or leakage characteristics data associated with the enclosure. The one or more processors are further configured to generate a third control signal for the controller for controlling the testing device based on the test data.

In an embodiment, the fluid may include at least a portion of aerosolized sealant.

In another aspect, a method for controlling an operation of a testing device for performing an air leakage test. The method includes transmitting a first predefined control signal to the testing device to initiate the operation thereof. The method further includes in response to the first predefined control signal, causing the testing device to effect a continual increase in a volume of the fluid flowing into a flexible tubing until a termination condition is met. The termination condition is associated with reaching an inflated state of the flexible tubing from a deflated state. The testing device is in fluid connection with the flexible tubing. The method further includes receiving pressure data associated with each of the flexible tubing and an enclosure. The pressure data may be indicative of a pressure within each of the flexible tubing and the enclosure when the inflated state of the flexible tubing is reached. The enclosure is in fluid connection with the flexible tubing. The method further includes comparing the received pressure data to a predefined target pressure value. The method further includes generating a second control signal for a controller for controlling the testing device based on the comparison. The method further includes controlling, using the controller, the operation of the testing device to cause an increase in the pressure within the enclosure to reach the predefined target pressure value based on the second control signal.

In an embodiment, the method further includes continuously receiving updated pressure data associated with each of the flexible tubing and the enclosure. The method further includes comparing the received updated pressure data to the predefined target pressure value. The method further includes determining whether a pressure within at least the enclosure is greater than the predefined target pressure value. The method further includes controlling, using the controller, the operation of the testing device to maintain the pressure within the enclosure.

In an embodiment, the testing device is a fan operable to supply pressurized air to each of the flexible tubing and the enclosure.

In an embodiment, the method further includes controlling, using the controller, a rotation speed of the fan in response to the second control signal. The rotation speed is controlled to reach and maintain the predefined target pressure value of the fluid within at least the enclosure.

In an embodiment, the method further includes calculating a pressure difference based on the comparison between the pressure data and the predefined target pressure value. The method further includes generating the second control signal for the controller based on the pressure difference.

In an embodiment, the method further includes transmitting, to the controller, the second control signal, wherein the controller is connected to the testing device. The method further includes controlling, using the controller, the operation of the testing device to reach and maintain the predefined target pressure value of the fluid within at least the enclosure.

In yet another aspect, a computer programmable product including a non-transitory computer readable medium having stored thereon computer executable instructions for controlling an operation of a testing device for performing an air leakage test, which when executed by one or more processors, cause the one or more processors to carry out operations. The operations may include transmitting a first predefined control signal to the testing device to initiate the operation thereof. The operations further include causing the testing device to effect a continual increase in a volume of the fluid flowing into a flexible tubing until a termination condition is met in response to the first predefined control signal. The termination condition is associated with reaching an inflated state of the flexible tubing from a deflated state. The testing device is in fluid connection with the flexible tubing. The operations further include receiving pressure data associated with each of the flexible tubing and an enclosure. The pressure data may be indicative of a pressure within each of the flexible tubing and the enclosure when the inflated state of the flexible tubing is reached. The enclosure is in fluid connection with the flexible tubing. The operations further include comparing the received pressure data to a predefined target pressure value. The operations further include generating a second control signal for a controller for controlling the testing device based on the comparison. The operations further include controlling the operation of the testing device to cause an increase in the pressure within the enclosure to reach the predefined target pressure value using the controller based on the second control signal.

In an embodiment, the operations further include continuously receiving updated pressure data associated with each of the flexible tubing and the enclosure. The operations further include comparing the received updated pressure data to the predefined target pressure value. The operations further include determining whether the pressure within at least the enclosure is greater than the predefined target pressure value. The operations further include controlling, using the controller, the operation of the testing device to maintain the pressure within the enclosure.

In an embodiment, the testing device is a fan operable to supply pressurized air to each of the flexible tubing and the enclosure. The operations further include controlling, using the controller, a rotation speed of the fan in response to the second control signal. The rotation speed is controlled to reach and maintain the predefined target pressure value of the fluid within at least the enclosure.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Having thus described example embodiments of the invention in general terms, reference will now be made to the accompanying drawings, which are not necessarily drawn to scale, and wherein:

FIG. 1 illustrates a block diagram of a network environment in which a system for controlling an operation of a testing device for performing an air leakage test is implemented, in accordance with one or more embodiments of the present disclosure;

FIG. 2 illustrates a block diagram of a system the FIG. 1, in accordance with an embodiment of the disclosure;

FIG. 3 illustrates an exemplary schematic diagram of air leakage testing using a leakage inspection equipment, in accordance with an exemplary embodiment of the present disclosure;

FIG. 4A illustrates exemplary operations for controlling the operation of the testing device for performing the air leakage test, in accordance with an example embodiment of the present disclosure;

FIG. 4B illustrates exemplary schematic diagram for controlling the operation of the testing device, in accordance with an example embodiment the present disclosure;

FIG. 5 illustrates an exemplary flowchart of a method for identifying control parameters for controlling the operation of the testing device, in accordance with an example embodiment of the present disclosure; and

FIG. 6 illustrates an exemplary flowchart of a method for controlling the operation of the testing device for performing the air leakage test, in accordance with the present disclosure.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, systems and methods are shown in block diagram form only in order to avoid obscuring the present disclosure.

Some embodiments of the present disclosure will now be described more fully hereinafter with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout. Also, reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

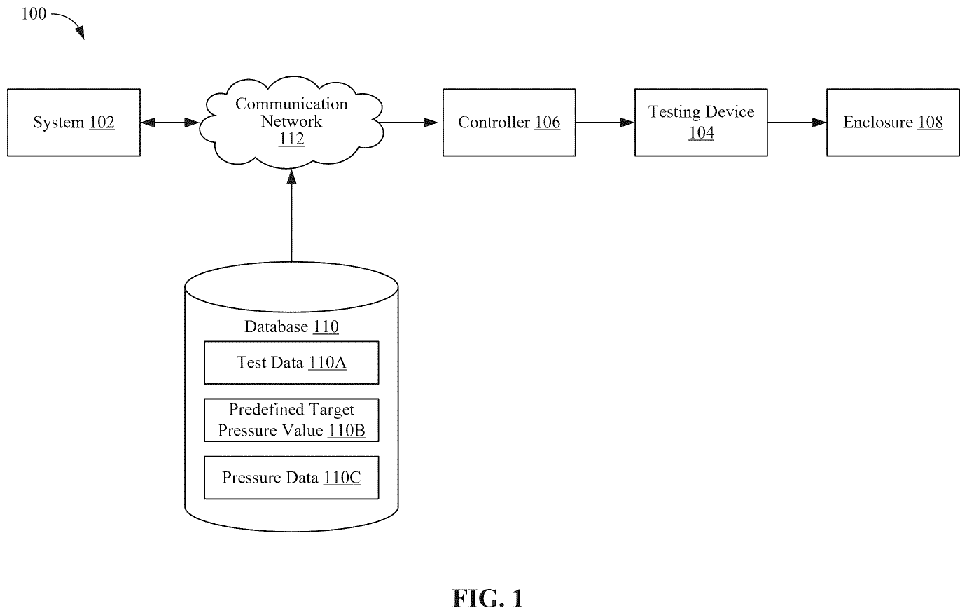

The embodiments are described herein for illustrative purposes and are subject to many variations. It may be understood that various omissions and substitutions of equivalents are contemplated as circumstances may suggest or render expedient but are intended to cover the application or implementation without departing from the spirit or the scope of the present disclosure. Further, it may be understood that the phraseology and terminology employed herein are for the purpose of the description and should not be regarded as limiting. Any heading utilized within this description may be for convenience only and has no legal or limiting effect. Turning now to FIG. 1-F IG. 6, a brief description concerning the various components of the present disclosure will now be briefly discussed. Reference will be made to the figures showing various embodiments of a system, and a method for controlling an operation of a testing device for performing an air leakage test.

FIG. 1 illustrates a block diagram of a network environment 100 in which a system 102 for controlling an operation of a testing device 104 for performing an air leakage test is implemented, in accordance with one or more embodiments of the present disclosure. The network environment 100 may include the system 102, a controller 104, a testing device 106, an enclosure 104, a database 108, and a communication network 112.

The air leakage test refers to a method to verify the presence of one or more leaks in an enclosure, such as a building, a room, etc. The air leakage tests may be followed by sealing of the identified leaks. The air leakage test, also known as a blower door test, is a diagnostic procedure used to measure a rate at which air infiltrates or exfiltrates through the enclosure, such as a building's envelope. The building envelope consists of all the external components of a structure, including walls, floors, roofs, doors, and windows, that separate the interior from the exterior environment. The purpose of the air leakage test is to assess the airtightness of the building's envelope and identify areas where air leakage occurs, which can affect energy efficiency, indoor air quality, and occupant comfort. The overall process of the air leakage test may be performed in a series of steps.

Firstly, installation of a testing device is performed. A testing device assembly may include a powerful fan or a blower, a frame, and a flexible panel. The testing device assembly may be installed in an exterior doorway. The panel may seal a door frame of the enclosure, ensuring that air coming out of the fan moves through the fan to inside of the enclosure.

Thereafter, a pressure difference operation is performed. The testing device is used to create a pressure difference between the inside and the outside of the enclosure of the building, typically by depressurizing the interior. This pressure difference forces air through any gaps, cracks, or openings in the building envelope.

Further, a measurement operation of air flow rate is performed. The rate of air flow required to maintain the pressure difference may be measured, usually in cubic feet per minute (CFM) or liters per second (L/s). Specialized equipment, such as manometers and flow meters, may be utilized to obtain accurate readings.

At the end, an analysis for leaks is done for air leakage test. The measured air flow rate may be compared to standard benchmarks to determine a level of airtightness and/or size of air leaks. Areas of significant leakage are identified using techniques, such as smoke pencils, infrared cameras, or handheld anemometers.

The leakage once verified is then sealed during the sealing process. The sealing process requires a pressurized enclosure to direct sealant to leaks by utilizing the testing device. In this regard, a sealing system injects adhesive particles into the enclosure using the testing device. The adhesive or sealant particles travel through the enclosure seeking holes and cracks that are located throughout the enclosure. The adhesive duct sealing particles attach directly onto the edges of any hole and crack, effectively sealing it without coating the inside of the enclosure.

The air leakage test requires the enclosure to be pressurized to a specific target pressure to measure air leakage accurately. Precise control of the testing device is needed to maintain this specific target pressure. Improper control of the testing device results in an inaccurate detection of the leaks. Further, the sealing process requires a pressurized enclosure to direct sealant to the leaks. The rotation of the testing device provides the necessary airflow for pressurizing the enclosure. The enclosure has a predefined limit of maximum safe pressure which needs to be maintained to avoid any physical damage. Therefore, a precise control of the rotation of the testing device needs to be maintained. The improper control of the testing device can cause damage to the enclosure itself as well as its surroundings. Furthermore, the enclosure should be properly sealed for the proper detection and sealing of the leaks.

Conventionally, a testing device is operated in an open loop setting. Usually, the testing device is operated at a constant speed or may be manually operated to maintain a constant flow of a fluid inside an enclosure. But as the enclosure reaches the maximum pressure it can handle, can cause physical damage. To overcome these issues there is a need for a close loop feedback system for controlling the operation of the testing device to maintain the specific target pressure inside the enclosure. Further, the close loop system is needed to avoid over pressurizing the enclosure.

The present disclosure discloses the system 102 that utilizes a closed loop control for controlling the operation of the testing device 104. In the present disclosure, the system 102 is configured to control the operation of the testing device 104 to perform the air leakage test. The system 102 is configured to receive 106 pressure data 110C as feedback from pressure sensor(s) associated with a flexible tubing and the enclosure 108. The system 102 compares a pressure data 110C with a predefined target pressure value 110B to control the operation of the testing device 104.The system 102 may include suitable logic, circuitry, interfaces, and/or code that may be configured to control operations of the testing device 104 for performing an air leakage test. Examples of the system 102 may include, but are not limited to, an electronic control unit (ECU), an electronic control module (ECM), a computing device, a mainframe machine, a server, a computer workstation, any and/or any other device.

In another example embodiment, the system 102 may be embodied as a cloud-based service, a cloud-based application, a cloud-based platform, a remote server-based service, a remote server-based application, a remote server-based platform, or a virtual computing system. In yet another example embodiment, the system 102 may be an OEM (Original Equipment Manufacturer) cloud.

The testing device 104 is a rotation device operable to supply the fluid to the enclosure 108 for performing the air leakage test. In an example, the testing device 104 may be a blower or a fan. The testing device 104 is connected to the enclosure 108 to provide fluid inside the enclosure 108. The testing device 104 allows air to be forced through the enclosure 108 and any existing leaks. In an example, the testing device 104 may pressurize the enclosure 108 to the desired predefined target pressure value 110B.

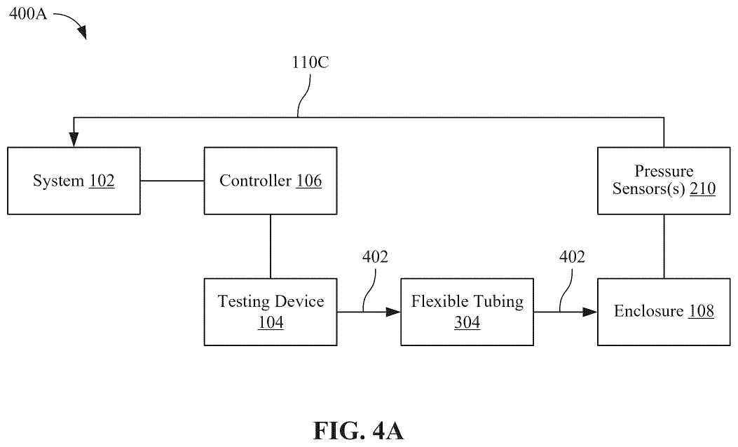

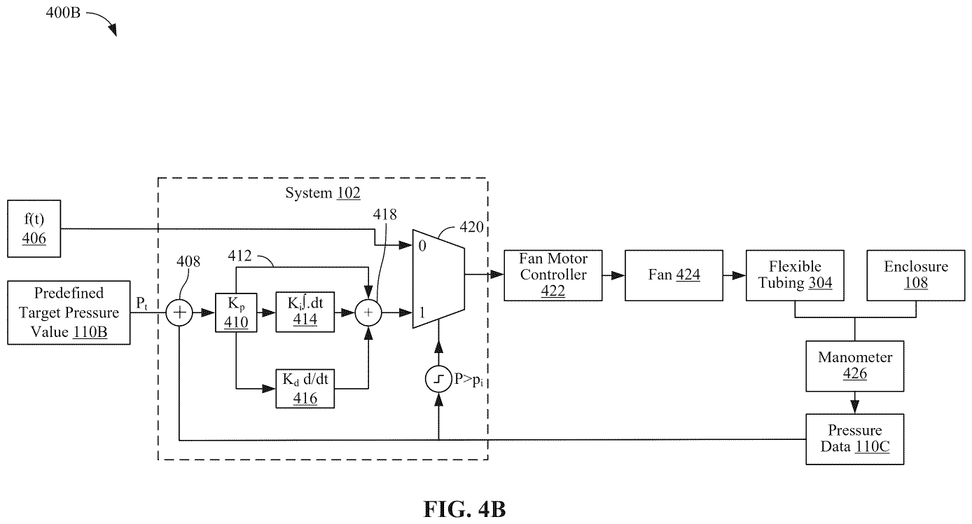

The controller 106 may be a logic circuitry for controlling the operation of the testing device 104. The controller 106 may be connected with the testing device 104 for controlling the operations of the operations of the testing device. In an example, the controller 106 may include one of, but not limited to, a proportional (P) controller, an integral (I) controller, a derivative (D) controller, or a PI controller. Further, operations of the testing device 104 are described in the FIG. 4.

The database 110 is an organized collection of structured information, or data, typically stored electronically in a computer system. The database 110 is configured to receive, store, and transmit data that may be collected from various sensors. The database 110 stores test data 110A, predefined target pressure value 110B, and pressure data 110C. The test data 110A may be data associated with flow of the fluid inside the enclosure 108 or pressure inside the enclosure 108. The pressure data 110C may be associated with a pressure of the fluid inside the flexible tubing and the enclosure 108.

The communication network 112 may be wired, wireless, or any combination of wired and wireless communication networks, such as cellular, Wi-Fi, internet, local area networks, or the like. In some embodiments, the communication network 112 may include one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks (for e.g. LTE-Advanced Pro), 5G New Radio networks, ITU-IMT 2020 networks, code division multiple access (CDMA), wideband code division multiple access (WCDMA), wireless fidelity (Wi-Fi), wireless LAN (WLAN), Bluetooth, Internet Protocol (IP) data casting, satellite, mobile ad-hoc network (MANET), and the like, or any combination thereof.

The system 102 may be embodied as a device or a component for sending and receiving electronic signals for controlling a configuration or an operation of the testing device 104. The system 102 may receive an input signal from the system 102 and accordingly generate an output signal to control a setting of the testing device 104 for performing the leakage test. Further, the system 102 may be configured to generate one or more control signals for controlling the operation of the testing device 104. Each of the one or more control signals may correspond to at least one of a first predefined control signal, or a second control signal. Examples of the system 102 may include, one of but not limited to, a programmable logic controller (PLC), a microsystem, a sensor-based system, an electronic control unit (ECU), an electronic control module (ECM), a computing device, a server, or/and any other device.

In operation, the system 102 is configured to transmit the first predefined control signal to the testing device 104 to initiate the operation thereof. In an example, a control signal is a pulse or frequency of electricity or light that represents a control command as it travels over a network, a computer channel or wirelessly. The control signal may be an output of learning and processing block, which are sent to different output interfaces to produce desired output in the real physical world.

In an example, the first predefined control signal may indicate controlling of the testing device 104 based on first control parameters. For example, the first predefined control signal may be associated with a first control operation of the testing device 104 to initiate the testing device 104.

In an example, the enclosure 108 may be a building envelope, a duct or a conduit to which an HVAC system is connected for supplying conditioned air. In an example, the enclosure 108 may be, for example, a type of sheet metal duct, where these ducts are made from galvanized steel or aluminum and are unlikely to harbor mold. In another example, the enclosure 108 may further be, for example, a type of flex duct. In yet another example, the enclosure 108 may be a summation of the duct as well as the space which is to be conditioned. The testing device 104 may be fluidly connected with the enclosure 108 through a flexible tubing to supply the fluid thereto. For example, the testing device 104 is a fan operable to supply pressurized air to each of the flexible tubing and the enclosure 108. The pressurized air may be supplied to the flexible tubing and the enclosure 108 for performing the air leakage test and/or sealing process. To this end, the fluid may include air, or at least a portion of aerosolized sealant mixed with the air.

In an example embodiment, the first control parameters are predetermined for the purpose of inflating the flexible tubing while not exceeding a safe maximum pressure. The first control parameters may include, but are not limited to, a first speed of the testing device 104, and a first pressure to be generated by the testing device 104.

In an embodiment, the system 102 may be configured to cause the testing device 104 to effect a continual increase in a volume of the fluid flowing into the flexible tubing in response to the first predefined control signal, until a termination condition is met. The termination condition is associated with reaching an inflated state of the flexible tubing from the deflated state. The testing device 104 is in fluid connection with the flexible tubing.

Subsequently, the system 102 is configured to receive the pressure data 110C associated with each of the flexible tubing and the enclosure 108. The pressure data 110C is indicative of a pressure within each of the flexible tubing and the enclosure when the inflated state of the flexible tubing is reached. The pressure data 110C may be received from a one or more pressure sensor(s) arranged in connection with each of the flexible tubing and the enclosure 108. The one or more pressure sensors may correspond to a manometer. The enclosure 108 is in fluid connection with the flexible tubing.

In an embodiment, the system 102 may be configured to compare the received pressure data 110C to the predefined target pressure value 110B. The predefined target pressure value 110B may correspond to a pressure value needed to be maintained inside the enclosure 108. In an example, the pressure data 110C is continuously received, and the received pressure data 110C is continuously compared with the predefined target pressure value 110B. The comparison is performed to ascertain if pressure value of the received pressure data 110C is smaller or substantially equal to the predefined target pressure value 110B.

Continuing further, the system 102 is configured to generate a second control signal for the controller 106 for controlling the testing device 106 based on the comparison. The second control signal may indicate second control parameters for controlling the operation of the testing device 104. The second control signal may be generated in response to determining that the pressure within the enclosure 108 is less than the predefined target pressure value 110B.

In an embodiment, the system 102 is configured to control the operation of the testing device 104 using the controller 106 to cause an increase in the pressure within the enclosure to reach the predefined target pressure value 110B. In particular, the system 102 may be configured to transmit the second control signal for controlling the operation of the testing device 104.

The system 102 may cause the testing device 104 to effect an increase in a pressure of the fluid within the enclosure 108, in response to the first predefined control signal. In this regard, the pressure inside the enclosure 108 may be increased from a first pressure value to a second pressure value till the pressure reaches the target pressure value 110B. For example, such an increase in the pressure within the enclosure 108 may be due to the supply of the fluid from the testing device 104 to the enclosure 108. Further, a change in pressure within the enclosure 108 may be measured and transmitted to the system 102, for example, by the pressure sensor(s) arranged within the enclosure 108.

In an example, the testing device 104 may be a fan. The fan may be controlled via a controller. To this end, the system 102 may be configured to generate and transmit the second control signal to the controller. In response to receiving the second control signal, the controller may control a rotational speed of the fan. The rotation speed of the fan is controlled to reach and maintain the predefined target pressure value within at least the enclosure 108.

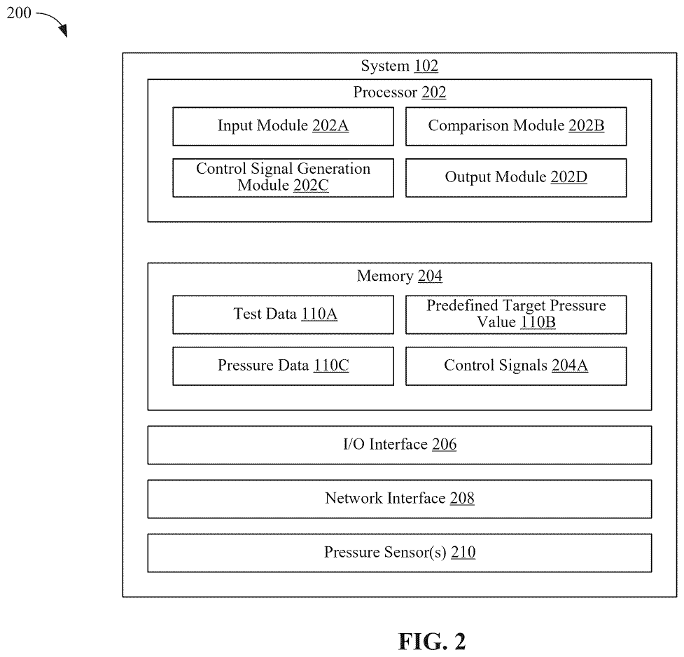

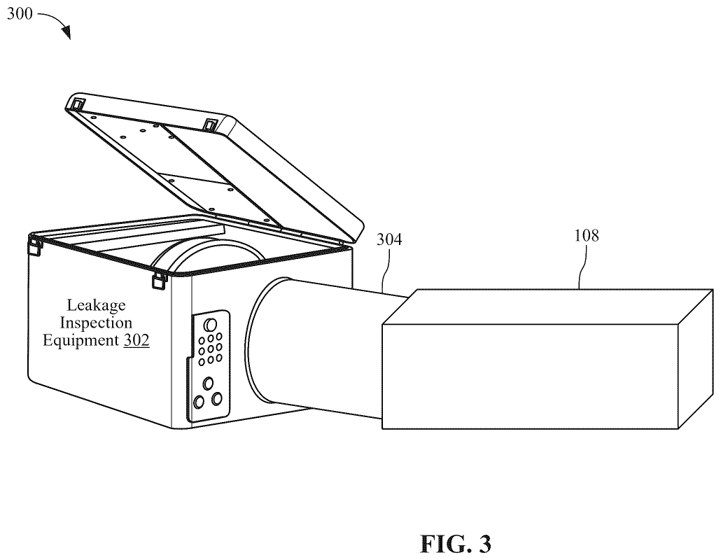

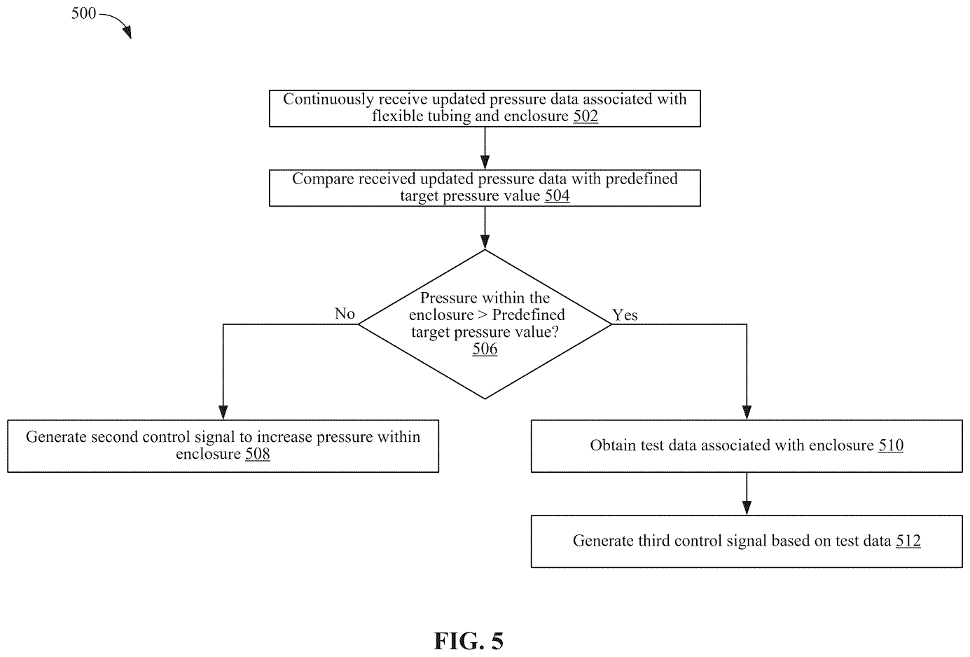

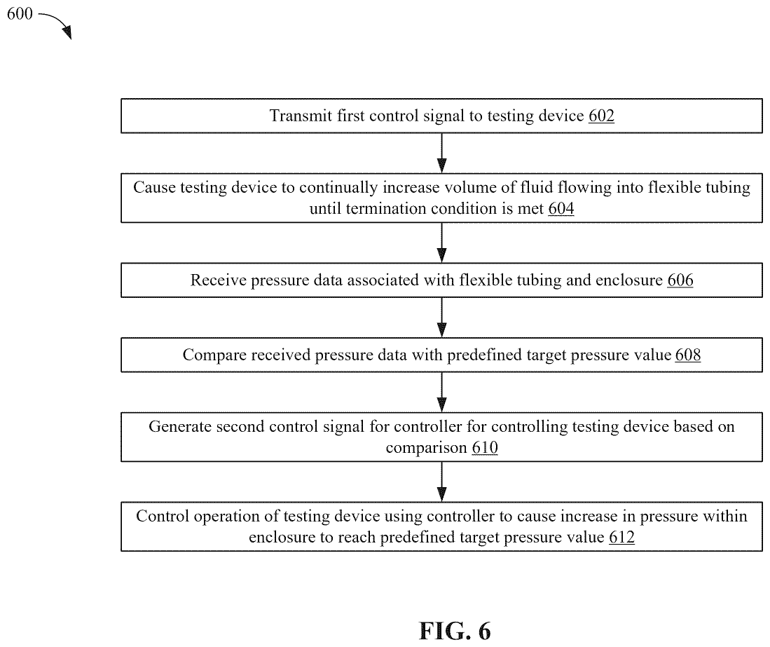

The functions or operations executed by the system 102 are described in detail, for example, in conjunction with FIG. 2, FIG. 3, FIG. 4A, FIG. 4B, FIG. 5 and FIG. 6.

FIG. 2 illustrates a block diagram 200 of the system 102 for performing an air leakage test for the enclosure 108, in accordance with an embodiment of the disclosure. The system 102 may include the system 102 comprising at least one processor (referred to as a processor 202, hereinafter), at least one non-transitory memory (referred to as a memory 204, hereinafter), an input/output (I/O) interface 208, a network interface 208, and pressure sensor(s) 210. The processor 202 may include modules, depicted as, an input module 202A, a comparison module 202B, a control signal generation module 202C, and an output module 202D. Although the present illustration depicts the system 102 to include the processor 202, this should not be construed as a limitation. In other examples, the system 102 and the processor 202 may not be co-located and may operate independently or inter-dependently.

The processor 202 may be connected to the memory 204, the I/O interface 208, and the network interface 208 through one or more wired or wireless connections. Although in FIG. 2, it is shown that the system 102 includes the processor 202, the memory 204, the I/O interface 208, and the network interface 208 however, the disclosure may not be so limiting and the system 102 may include fewer or more components to perform the same or other functions of the system 102.

In accordance with an embodiment, the system 102 may store data received and/or generated by the modules of the processor 202 in the memory 208. The data received and/or generated by the modules may include, for example, the test data 110A, the predefined target pressure value 110B, the pressure data 110C and control signals 204A.

The system 102 of the system 102 may be configured to control the operation of the testing device 104. The system 102 may be operatively connected with the pressure sensors(s) 210. The system 102 receives the pressure data 110C from the pressure sensor(s) 210. The processor 202 utilizes the received pressure data 110C to control the testing device 104 for performing the air leakage test. In an example, the system 102 may include, but are not limited to, an electronic control unit (ECU), an electronic control module (ECM), a computing device, a mainframe machine, a server, a computer workstation, any and/or any other device.

The processor 202 of the system 102 may be configured to perform the air leakage test for the enclosure 108. The processor 202 may be embodied as one or more of various hardware processing means such as a coprocessor, a microprocessor, a digital signal processor (DSP), a processing element with or without an accompanying DSP, or various other processing circuitry including integrated circuits such as, for example, an ASIC (application-specific integrated circuit), an FPGA (field programmable gate array), a microsystem unit (MCU), a hardware accelerator, a special-purpose computer chip, or the like. As such, in some embodiments, the processor 202 may include one or more processing cores configured to perform independently. A multi-core processor may enable multiprocessing within a single physical package. Additionally, or alternatively, the processor 202 may include one or more processors configured in tandem via the bus to enable independent execution of instructions, pipelining, and/or multithreading. Additionally, or alternatively, the processor 202 may include one or more processors capable of processing large volumes of workloads and operations to provide support for big data analysis. In an example embodiment, the processor 202 may be in communication with the memory 204 via a bus for passing information among components of the system 102.

For example, when the processor 202 may be embodied as an executor of software instructions, the instructions may specifically configure the processor 202 to perform the algorithms and/or operations described herein when the instructions are executed. However, in some cases, the processor 202 may be a processor-specific device (for example, a mobile terminal or a fixed computing device) configured to employ an embodiment of the present disclosure by further configuration of the processor 202 by instructions for performing the algorithms and/or operations described herein. The processor 202 may include, among other things, a clock, an arithmetic logic unit (ALU), and logic gates configured to support the operation of the processor 202. The network environment, such as 100 may be accessed using the network interface 208 of the system 102. The network interface 208 may provide an interface for accessing various features and data stored in the system 102.

In an example, the processor 202 may be configured to retrieve a first predefined control signal. Moreover, the output module 202D may be configured to transmit the first predefined control signal to the controller 106 of the testing device 104. Based on the first predefined control signal, the controller 106 may control to initiate the operation of the testing device 104. In an example, the first predefined control signal may be stored as the control signals 204A within the memory 204.

Once the controller 106 receives the first predefined control signal, the operation of the testing device 104 is initiated, i.e., the testing device 104 is triggered to supply a fluid to the enclosure 108. In this regard, the testing device 104 may effect a continual increase in a volume of the fluid flowing into a flexible tubing until a termination condition is met. The testing device 104 may supply the fluid such that the volume of the fluid starts to increase in the flexible tubing. For example, the flexible tubing may be a flexible duct, such as a layflat, positioned between the testing device 104 and the enclosure 108. In this manner, the testing device 104 is in fluid connection with the flexible tubing. To this end, the supply of the fluid increases the volume of the fluid in the flexible tubing thereby expanding the flexible tubing. For example, the flexible tubing keeps expanding until the termination condition is met, i.e., the flexible tubing reaches an inflated state from a deflated state. In other words, during this period, the flow and the pressure of the fluid supplied by the testing device 104 changes a state of the flexible tubing from the deflated state to the inflated state.

Once the flexible tubing reaches the inflated state, i.e., the flexible tubing is completely inflated, the input module 202A is configured to receive pressure data 110C associated with the flexible tubing and the enclosure 108. The pressure data 110C is indicative of a pressure within the flexible tubing and the enclosure 104 when the inflated state of the flexible tubing is reached. Moreover, the enclosure 108 is in fluid connection with the flexible tubing. It may be noted that the fluid supplied by the testing device 104 may travel to the enclosure 108 via the flexible tubing. The pressure data 110C may be data received from the pressure sensor(s) 210.

In an exemplary embodiment, the input module 202A may also be configured to obtain the predefined target pressure value 110B. The predefined target pressure value 110B may be obtained as a user input data or may be obtained by a user selection from the database 110.

Thereafter, the comparison module 202B may be configured to compare the pressure data 110C received by the input module 202A from the pressure sensor(s) 210 with the predefined target pressure value 110B. The testing device 104 may be further controlled based on the comparison. In an example, the predefined target pressure value 110B may be obtained as a user input data from the input module 202A or may be retrieved from the database 110. In an embodiment, the comparison module 202B may be configured to control a comparator for comparison. The comparator may be a device or an electronic circuit for comparing something measurable with a reference or standard. The comparator may be for example, but not limited to, a voltage comparator, a window comparator, or a hysteresis comparator.

Based on an output of the comparison module 202B, the control signal generation module 202C may be configured to generate a second control signal for controlling the testing device for performing the air leakage test. The second control signal generation module 204C may determine second control parameters for the testing device 104. The control signal generation module 202C may determine the second control parameters based on the comparison between the pressure data 110C with the predefined target pressure value 110B. The control signal generation module 202C may determine the second control parameters based on whether the pressure within the enclosure 108 is greater than or lesser than the predefined target pressure value 110B. In an example, the control signal generation module 202C may generate the second control signal that is transmitted to the controller 106. In certain cases, the control signal generation module 202C may utilize a proportional integral derivative (PID) controller to generate the second control signal based on when the comparison between the pressure data 110C and the predefined target pressure value 110B.

The output module 202D may transmit the second control signal to the controller 106. Thereafter, the controller 106 may control the testing device 104 based on the second control signal. In an example the output module 202D may be configured to control a multiplexer to output the one or more control signals for controlling the testing device 104.

In an example embodiment, the processor 202 may also be configured to obtain the test data 110A associated with the enclosure 108 in response to controlling the operation of the testing device 104 to maintain the predefined target pressure value 110B within the enclosure 108. In particular, based on the second control signal, the processor 202 causes the controller 106 to control the testing device 104 so that the pressure within the enclosure 108 reaches the predefined target pressure value 110B. Once update pressure data indicates that the pressure within the enclosure 108 has reached the predefined target pressure value 110B, the processor 202 may obtain test data associated with the enclosure 108. In an example, the test data may include pressure characteristics data associated with the enclosure 108, flow characteristics data associated with the enclosure 108, and/or leakage characteristics data associated with the enclosure 108.

Subsequently, the processor 202, for example, the control signal generation module 202C, may be configured to generate a third control signal for the controller 106 for controlling the testing device 104 based on the test data 110A. In an example, the test data 110A may indicate leakage characteristics of one or more air leaks within the enclosure 108. Based on the test data 110A, the third control signal may be generated to, for example, maintain a desired pressure level within the enclosure 108. For example, such desired pressure level may correspond to the predefined target pressure value 110B.

The memory 204 may be non-transitory and may include, for example, one or more volatile and/or non-volatile memories. In other words, for example, the memory 204 may be an electronic storage device (for example, a computer readable storage medium) comprising gates configured to store data (for example, bits) that may be retrievable by a machine (for example, a computing device like the processor 202). The memory 204 may be configured to store information, data, content, applications, instructions, or the like, for enabling the system 102 to carry out various functions in accordance with an example embodiment of the present disclosure. For example, the memory 204 may be configured to buffer input data for processing by the processor 202. As exemplified in FIG. 2, the memory 204 may be configured to store instructions for execution by the processor 202. As such, whether configured by hardware or software methods, or by a combination thereof, the processor 202 may represent an entity (for example, physically embodied in circuitry) capable of performing operations according to an embodiment of the present disclosure while configured accordingly. Thus, for example, when the processor 202 may be embodied as an Application Specific Integrated Circuit (ASIC), Field Programmable Gate Array (FPGA), or the like, the processor 202 may be specifically configured hardware for performing the operations described herein.

The memory 204 of the system 102 may be configured to store the test data 110A. The test data 110A may include pressure characteristics data, flow characteristic data or leakage characteristic data. In an embodiment, the test data 110A may include the pressure characteristics data indicating pattern of change in pressure of the fluid within the flexible tubing and the enclosure 108 to maintain the predefined target pressure value in the enclosure 108 and the flexible tubing. The predefined target pressure value 110B may be the pressure value needed to be maintained inside the enclosure 108 for performing the air leakage test and/or sealing operations. The predefined target pressure value 110B may be received from the database 110. In an exemplary embodiment, the predefined target pressure value 110B may be obtained as a user input data from the input. In an exemplary embodiment, the predefined target pressure value 110B may be calculated based on characteristics of the enclosure 108. The predefined target pressure value 110B may be obtained to compare with the pressure data 110C by using the comparison module 202B.

The second control signal may include the second control parameters for controlling the testing device 104. The memory 204 of the system 102 may be configured to store the second control signal received from the control signal generation module 202C to cause the controller 106 to control the testing device 104. The second control signal may be generated by the control signal generation module 202C based on the comparison between the predefined target pressure value 110B and the pressure data 110C.

In some example embodiments, the I/O interface 208 may communicate with the system 102 and display the input and/or output of the system 102. As such, the I/O interface 208 may include a display and, in some embodiments, may also include a keyboard, a mouse, a touch screen, touch areas, soft keys, or other input/output mechanisms. In one embodiment, the system 102 may include a user interface circuitry configured to control at least some functions of one or more I/O interface elements such as a display and, in some embodiments, a plurality of speakers, a ringer, one or more microphones and/or the like. The processor 202 and/or the I/O interface 208 circuitry including the processor 202 may be configured to control one or more functions of one or more I/O interface 208 elements through computer program instructions (for example, software and/or firmware) stored on the memory 204 accessible to the processor 202.

The network interface 208 may include the input interface and output interface for supporting communications to and from the system 102 or any other component with which the system 102 may communicate. The network interface 208 may be any means such as a device or circuitry embodied in either hardware or a combination of hardware and software that may be configured to receive and/or transmit data to/from a communications device in communication with the system 102. In this regard, the network interface 208 may include, for example, an antenna (or multiple antennae) and supporting hardware and/or software for enabling communications with a wireless communication network 112. Additionally, or alternatively, the network interface 208 may include the circuitry for interacting with the antenna(s) to cause transmission of signals via the antenna(s) or to handle receipt of signals received via the antenna(s). In some environments, the network interface 208 may alternatively or additionally support wired communication. As such, for example, the network interface 208 may include a communication modem and/or other hardware and/or software for supporting communication via cable, digital subscriber line (DSL), universal serial bus (USB), or other mechanisms.

The pressure sensor(s) may be devices used to measure the pressure of gases or liquids and convert this information into an electrical signal. In an embodiment, the pressure sensor(s) 210 may be spread across the enclosure 108 as well as the flexible tubing to provide a suitable environment for measuring the accurate pressure inside the enclosure 108. In an example, examples of the pressure sensor(s) 210 may include, but are not limited to, Aneroid, Barometer Pressure, Sensor Manometer, Pressure Sensor, Bourdon Tube Pressure Sensor, Vacuum (Pirani) Pressure Sensor, Sealed Pressure Sensor, Piezoelectric Pressure Sensors. The pressure sensor(s) may be configured to generate the pressure data associated with each of the flexible tubing and the enclosure 108.

FIG. 3 illustrates an exemplary schematic diagram 300 of air leakage testing using a leakage inspection equipment 302, in accordance with an exemplary embodiment of the present disclosure. With reference to FIG. 3, the leakage inspection equipment 302 is coupled to the enclosure 108 via a flexible tubing 304. FIG. 3 is explained in conjunction with elements of FIG. 1 and FIG. 2.

The leakage inspection equipment 302 of the present disclosure may include several key components for the purpose of leakage tests and/or sealing operations. In an example embodiment, the leakage inspection equipment 302 may include the testing device 104. The testing device 104 may be a fan operable to supply air to the enclosure 108 for performing the air leakage test. In an example, the testing device 104 may be a blower or fan, that can pressurize the enclosure 108 to a desired test pressure. The testing device 104 allows air to be forced through the enclosure 108 and any existing leaks. The leakage inspection equipment 302 may further include pressure indicating devices, such as pressure gauges or manometers, to measure the pressure inside the enclosure 108 as the pressure data 110C. The leakage inspection equipment 302 may further include a fluid storage unit for supplying a fluid inside the enclosure 108.

Additionally, the leakage inspection equipment 302 may further include one or more accessories, for example, but not limited to, tubing, fittings, and sealing materials, to facilitate the proper integration of the testing device 104 and one or more pressure ports with the enclosure 108 under test. The one or more accessories may ensure that the testing device 104 can be effectively connected to the enclosure 108 for accurate air leakage tests.

The flexible tubing 304 may correspond to the flexible tubing described in the FIG. 1. The flexible tubing 304 may allow a passage and a direction of the generated fluid from the testing device 104 (or a fan) to the enclosure 108. The fluid may include air, or at least a portion of aerosolized sealant mixed with the air. Structurally, the flexible tubing 304 may extend from an air movement device, on the fan side, to the enclosure 108 at its inlet. At the inlet, the flexible tubing 304 delivers the fluid. Towards the side of the leakage inspection equipment 302, the flexible tubing 304 may be shaped to complement and fasten over fixtures (not shown) within the leakage inspection equipment 302. Towards the enclosure 108 side, the flexible tubing 304 may similarly extend to connect and communicate with the enclosure's inlet. In an example, initially the flexible tubing 304 may be in the deflated state and as the fluid may be pumped through the flexible tubing 304 using the testing device 108 the flexible tubing 304 starts to inflate. The inflation of flexible tubing 304 may increase volume of the flexible tubing 304. The flexible tubing may be inflated till it matches the termination condition. The termination condition may be associated with reaching the fully inflated state. In another example, the termination condition may be associated with a threshold pressure value associated with the flexible tubing 304. The threshold pressure value may be the pressure value associated with the flexible tubing 304 after the flexible tubing 304 is fully inflated. The threshold pressure value may be the pressure value for inflating the flexible tubing 304 without exceeding a maximum safe pressure.

In an exemplary embodiment, the flexible tubing 304 may have a maximum safe pressure value which indicates the maximum safe pressure that the enclosure can safely handle. Reaching the maximum safe pressure value can damage the flexible tubing 304 as well as the surroundings.

In an exemplary embodiment, connections at any of the flexible tubing 304 ends may include bolting, snap fitting, and other conventional fastening means. The flexible tubing 304 may be manufactured from a waterproof and substantially flexible material to enable ease of assembly and operation. Further, high-grade plastics may be contemplated for the construction of the flexible tubing 304.

The enclosure 108 may correspond to the duct which may be coupled to the leakage inspection equipment 302 via the flexible tubing 304. In an embodiment, the enclosure 108 may be made from similar or dissimilar metallic materials such as galvanized steel, stainless steel, or aluminum, but is not limited thereto. It is hereby envisioned that a specific choice of materials used to make the enclosure 108 may be based on various factors including costs per unit length and environmental factors present at a location, for example, a site at which the installation is to be made. The enclosure 108 may have an opening where the testing device 104 is connected via the flexible tubing 304.

In an embodiment, the flexible tubing 304 and the enclosure 108 may form a pneumatic system. The flexible tubing 304 may inflate as the fluid passes through the flexible tubing 304. Before the full inflation of the flexible tubing 304, the pneumatic system is in a constant pressure mode. The flexible tubing 304 may be in constant pressure mode due to the weight of the flexible tubing 304 regulating the pressure value associated with the pneumatic system. Further, the pressure value associated with the pneumatic system may be regulated by a weight balancing the air pressure of the flexible tubing 304. As more air flows into the flexible tubing 304, it inflates and its volume increases. Once the flexible tubing 304 is fully inflated, its volume can't increase. The system 102 starts working in a constant volume mode. The material does not stretch at the pressures involved. At this point, the system 102 may switch to using the second control signal for controlling the testing device 104 for increasing the pressure inside the enclosure 108 to reach the predefined target pressure value 110B.

In an exemplary embodiment, the enclosure 108 may be used to distribute conditioned air (heated or cooled) throughout buildings, ensuring comfortable indoor temperatures. The enclosure 108 may also be used to provide ventilation in buildings, removing stale air and introducing fresh air. The enclosure 108 may further be used for maintaining indoor air quality and preventing mold or humidity buildup.

In another exemplary embodiment, the enclosure 108 may be used in commercial kitchens, enclosures remove cooking smoke, grease, and odors. The enclosure 108 may further be used in fire safety systems to evacuate smoke during emergencies. The enclosure 108 may be used in material handling, dust collection, and chemical processes. The enclosure 108 may be used to maintain air quality and prevent harmful emissions.

In an embodiment, the leakage inspection equipment 302 may further include the fluid storage unit configured to store and supply the fluid to the enclosure 108. The fluid may include at least a portion of aerosolized sealant. The aerosol sealant may be supplied to the enclosure 108 with the help of the testing device 104 creating an air flow inside the enclosure 108. The small aerosol particles of the sealant will remain suspended in the air due to continuous air movement. The particles travel through the air enclosure system seeking holes and cracks that are located throughout the enclosure 108. The adhesive enclosure sealing particles attach directly onto the edges of any hole and crack, effectively sealing it without coating the inside of the enclosure 108. In an example, the fluid storage unit may be a metal container. The fluid storage unit may be made from similar or dissimilar metallic materials such as galvanized steel, stainless steel, or aluminum, but is not limited thereto.

In one or more exemplary embodiments, the leakage inspection equipment 302 may be connected to the enclosure 108 to perform the air leakage test in a series of steps. In the first step, the system 102 may receive the test data 110A. The system 102 may generate the first predefined control signal to control the operation testing device 104 (fan) to supply the fluid to increase in the volume of the fluid flowing inside the flexible tubing 304. The fluid may be supplied to continuously increase the volume of the fluid flowing inside the flexible tubing 304 till it is fully inflated. The system 102 may control the operation of the testing device 104 using the controller.

Further, the system 102 may receive the pressure data 110C associated with the enclosure 108 from the pressure sensor(s) 210. The pressure data 110C may be compared with the predefined target pressure value 110B to determine whether the pressure data 110C is less than the predefined target pressure value 110B. The second control signal may be generated to control the testing device 104 when the pressure data 110C is less than the predetermined threshold pressure value 110B. The testing device 104 may be further controlled to increase the pressure value inside the enclosure 108 till the pressure value reaches the predefined target pressure value.

In another exemplary embodiment, the system may be configured to compare the pressure data 110C with the predefined target pressure value 110B. Upon determination that the pressure data 110C may be greater than the predefined target pressure value 110B, the system 102 may generate a third control signal for maintaining the predefined target pressure value 110B. The third control signal may control the operation of the testing device 104 using the controller 106. Further, the third control signal may be utilized for avoiding reaching the maximum pressure value. The third control signal may further be described in the FIG. 4A and FIG. 4B. Furthermore, all supply and return openings in the enclosure 108 under test may be sealed to ensure that the leakage measurements are accurate.

At the end, a leakage test data 110A is determined after maintaining the predefined target pressure value 110B. The leakage test data may refer to the measurements and results obtained during the process of air leakage test. This data is crucial for assessing the integrity and performance of the item being tested.

FIG. 4A illustrates a schematic flow diagram 400A of exemplary operations for controlling an operation of the testing device 104 for performing the air leakage test, in accordance with an example embodiment of the present disclosure. With reference to FIG. 4A, there is shown the flow diagram 400A that illustrates exemplary operations as described herein. The exemplary operations may be performed by the system 102 or the processor 202 of FIG. 2. Although illustrated with discrete blocks, the exemplary operations associated with one or more blocks of the block diagram 400A may be divided into additional blocks, combined into fewer blocks, or eliminated, depending on the implementation. FIG. 4A is explained in conjunction with FIG. 1, FIG. 2 and FIG. 3.

In an embodiment, the system 102 may correspond to the system 102 of the FIG. 1. In an exemplary embodiment the system 102 may include the control signal generation module 202C implemented using a PID controller for generating one or more control signals. The one or more control signals are further utilized to control the operation of the testing device 104.

In an embodiment, the testing device 104 may be configured to control the supply of a fluid 402 inside the enclosure 108. The testing device 104 may be controlled based on the one or more control signals received from the system 102. The testing device 104 may supply the fluid 402 to the enclosure 108 through the flexible tubing 304. The flexible tubing 304 allows passage and direction of the generated airflow from the testing device 104 to the enclosure 108. An amount of the fluid 402 supplied to the enclosure 108 by the testing device 104 is controlled using the controller 106 to increase and maintain a pressure value to the predefined target pressure value 110B for the air leakage test.

In an exemplary embodiment, the testing device 104 may be a fan configured to supply the fluid 402, such as air inside the enclosure 108. The fan may be controlled by the controller 106 based on the first predefined control signal and the second control signal. The first predefined control signal may include first control parameters that may be used to trigger the fan. The second control signal may contain second control parameters that may be used to reach and maintain the predefined target pressure value 110B within the enclosure 108.

In an embodiment, the pressure sensor(s) 210 may be configured to transmit the pressure data 110C of the enclosure 108. The pressure data 110C may be the pressure characteristic data associated with the enclosure 108 during the process of air leakage testing and/or leakage sealing. The pressure data 110C may indicate a measure of a pressure inside the enclosure 108 attached with the testing device 104. The pressure sensor(s) 210 may continuously measure the pressure data 110C associated with the enclosure 108 and iteratively transmit updated pressure data to the system 102 for controlling the operation of the testing device 104. The system 102 may further control the operation of the testing device 104 using the controller 106 to reach and maintain the predefined target pressure value 110B for performing air leakage testing and/or sealing operation. Details of the operations of system 102 are described in conjunction with, for example, FIG. 1 and FIG. 2.

In an embodiment, the pressure sensor(s) 210 may be spread across the enclosure 108 to provide a suitable environment for measuring accurate pressure values inside the enclosure 108. Examples of the pressure sensor(s) 210 may include, but are not limited to, aneroid barometer pressure sensor, manometer pressure sensor, bourdon tube pressure sensor, vacuum (pirani) pressure sensor, sealed pressure sensor, and piezoelectric pressure sensor.

The controller 106 may include suitable logic circuitry for controlling the operation of the testing device 104. The controller 106 may be connected with the testing device 104. The controller 106 may be configured to control the operation of the testing device 104 based on the received control signals 204A, such as the first predefined control signal and the second control signal. The control signals 204A may be generated by the system 102 and transmitted to the controller 106 for controlling operation of the testing device 104.

In an embodiment, the system 102 may be configured to transmit the first predefined control signal to the controller 106. The first predefined control signal may contain the first control parameters for controlling the testing device 104. The first control parameters may be predefined and may be retrieved or received from the database 110 to control the testing device 104 to continuously increase supply of the fluid into the flexible tubing. The fluid is continuously supplied to effect the continual increase in the volume of the fluid flowing into the flexible tubing until the flexible tubing may be fully inflated. Such inflation is performed without exceeding a safe pressure level within the flexible tubing 304 and/or the enclosure 108.

In an example, the flexible tubing may be continuously supplied with fluid until the flexible tubing is fully inflated. While the flexible tubing is inflating the pressure associated with the flexible tubing may not go above a small amount needed to fully inflate the flexible tubing. This may be due to the volume of the flexible tubing still increasing. The pressure in the flexible tubing increases above the threshold pressure value only once the flexible tubing has fully inflated.

In another embodiment, the system may be configured to transmit the second control signal to the controller 106. The second control signal 204A may include the second control parameters of the testing device 104. The second control parameters may include at least one of: speed of the fan, and pressure generated by the fan. The second control signal may be generated by the control signal generation module 202C. Further, the controller 106 may control the testing device 104 based on the received second control signal.

In another embodiment, the system 402 may generate and transmit a third control signal to the controller 106. In response to receiving the third control signal, the controller 106 may control the operation of the testing device 104 to reach and maintain the predefined target pressure value 110B of the fluid within the enclosure 108. The system 102 may continually receive the test data 110A from the sensor(s) in the enclosure 108, once the predefined target pressure value 110B is reached within the enclosure 108. The test data 110A may indicate attributes or parameters of the air leakage test or the sealing operation. For example, the test data 110A may include pressure characteristics data associated with the enclosure 108, flow characteristics data associated with the enclosure 108, or leakage characteristics data associated with the enclosure 108. To this end, the test data 110A may indicate a manner in which the pressure of the fluid 402 and/or the flow of the fluid 402 may vary over time in the enclosure, such as during the air leakage test or the sealing operation. Moreover, the test data 110A may indicate, for example, location of air leak, size of air leak, etc. Based on the test data 110A, the system 102 may generate the third control signal to reach and maintain the predefined target pressure value 110B within the enclosure 108 to continually perform the air leakage test or the sealing operation.

In an example, the third control signal may be generated when the pressure data 110C may be greater than the predefined target pressure value 110B, i.e., the desired pressure level has been reached in the enclosure 108. The third control signal may include third control parameters for controlling the testing device 104 to maintain the predefined target pressure value within the enclosure 108.

In an example, the controller 106 may include one of, but not limited to, a proportional (P) controller, an integral (I) controller, a derivative (D) controller, a PI controller, a PD controller, a PID controller, a fuzzy logic controller, an on-off controller, an adaptive controller, a model predictive controller, or a sliding mode controller.

In an exemplary embodiment, the controller 106 may be a proportional integral derivative (PID) controller. The PID unit may receive the second control signal from the control signal generation module 202C. The second control signal may include second control parameters of the testing device 104. The second control parameters may include at least one of speed of the fan, and pressure generated by the fan. The PID controller may control the testing device 104 based on the second control parameters to increase the pressure within the enclosure 108 to reach the predefined target pressure value 110B.

FIG. 4B illustrates exemplary schematic diagram of the system 102 for controlling the operation of a fan 424, in accordance with an example embodiment the present disclosure. FIG. 4B is explained in conjunction with elements of FIG. 1, FIG. 2, FIG. 3 and FIG. 4A.

The system 102 may be the suitable logic, circuitry, interfaces, and/or code that may be configured to control the operation of the fan 424 for performing the air leakage test or a sealing operation. The fan may correspond to the testing device 104. According to the present example, the system 102 may include an electronic circuitry to generate the control signals 204A and control the fan 424 using the generated control signals 204A.

The fan 424 may correspond to the testing device 104. In an example, a signal 406, such as the first predefined control signal transmitted to the fan 424 for initiating the operation of the fan 424. Further, a signal, such as the second control signal may be transmitted to the fan 424 till the flexible tubing 304 may be fully inflated. The fluid 402 may be continuously supplied to effect the continual increase in the volume of the fluid flowing into the flexible tubing 304 until the flexible tubing 304 may be fully inflated.

In an exemplary embodiment, the second control signal may be transmitted to a fan motor controller 422 till the termination condition is met. The fan motor controller 422 may correspond to the controller 106. The termination condition may be associated with the flexible tubing 304 reaching the fully inflated state.

Further, upon inflation of the flexible tubing 304 the system may be configured to receive the pressure data 110C. the pressure data 110C may be compared with the predefined target pressure value 110B using a comparator 408. In an example, the comparator 408 may be a voltage comparator. Furthermore, the system 102 may receive the pressure value 110B from the manometer 426. The manometer 426 may correspond to the pressure sensor(s) 210.

Throughout the operation of the fan 424, updated pressure data may be received at different time instants, such as t₀, t₁, t₂, . . . , tₙ. The comparator 408 may compare the pressure data 110C with the predefined target pressure value 110B. For each of the time instants, a determination is made whether the pressure value is less than the predefined target pressure value 110B or not.

Further, on determining the pressure value associated with the received pressure data at a particular time instant to be less than or greater than the predefined target pressure value 110B, the system 102 may generate the corresponding second control signal or the third control signal, respectively.

In an embodiment, the system may control the PID controller to generate the second control signal 204A and/or the third control signal. The PID controller may be an instrument used to regulate temperature, flow, pressure, speed, and other process variables in industrial control systems. PID controller may utilize a control loop feedback mechanism to control process variables.

In an embodiment, the system 102 may be configured to calculate a pressure difference 410 based on the comparison between the received pressure data 110C and the predefined target pressure value 110B. In an example, the pressure difference 410 may be a positive pressure difference or a negative pressure difference or a zero-pressure difference.

Further, the system 102 may be configured to generate the second control signal or the third control signal for the fan motor controller 422 based on the pressure difference. The fan motor controller 422 may control the operation of the fan 424 in response to receiving the second control signal or the third control signal. In an example, the control signal generation module 202C may be implemented using a PID controller that may utilize the pressure difference 410 to generate the second control signal or the third control signal. The PID controller may contain a proportional controller 412, an integral controller 414, and a differential controller 416.

The proportional controller 412 may be configured to provide a proportional correction factor proportional to the pressure difference 410. The pressure difference 410 may be multiplied with a proportional constant to get the proportional correction factor. In an example, the pressure difference 410 of zero may result in proportional correction factor to be zero.

The integral controller 414 may be configured to provide an integral correction factor. The integral controller 414 may integrate the pressure difference 410 over a period of time until the pressure difference 410 reaches zero. The integral controller 414 may hold the value to the final control device at which pressure difference 410 becomes zero. The integral controller 414 may be utilized to eliminate the steady-state error.

The differential controller 416 may be configured to provide a differential correction factor. The differential controller 416 may be utilized to predict a future behavior of. The differential controller 416 may anticipate the future behavior of the pressure difference 410 based on the rate of change of pressure difference 410 with respect to time, multiplied by derivative constant. The differential controller 416 may provide the kick start for the output thereby increasing system response.

The adder block 418 may be configured to receive the proportional correction factor, the integral correction factor, and the derivative correction factor to generate an overall correction factor. In an example, the adder block 418 may be a full adder, a carry look ahead adder, a ripple carry adder. The overall correction factor may be utilized to generate the second control signal to be transferred to the fan motor controller 422 to control the operations of the fan 424104 to reach the target pressure value within the enclosure 108.

In another embodiment, the system 102 may be configured to generate the third control signal based on the test data 110A. The system 102 may employ the above-mentioned PID controller to generate the third control signal. The system 102 may continually receive the test data 110A from the sensor(s) in the enclosure 108, once the predefined target pressure value 110B is reached within the enclosure 108. The test data 110A may indicate attributes or parameters of the air leakage test or the sealing operation. The PID controller may generate the third control signal based on the test data 110A to maintain the predefined target pressure value 110B within the enclosure 108 to continually perform the air leakage test or the sealing operation.

To this end, the system 102 may further control a multiplexer unit 420. The multiplexer unit 420 may be a device that selects between the first predefined control signal, the second control signal, or the third control signal based on the difference between the pressure value in the enclosure 108 and the predefined target pressure value 110B. Initially the multiplexer unit 420 may select the first predefined control signal to initiate or trigger the testing device or the fan 424. Further, the multiplexer unit 420 may select the second control signal until the flexible tubing 304 is fully inflated. After the inflation of the flexible tubing 304, the multiplexer unit 420 may select the third control signal. In an example, the multiplexer unit 420 may be a 4-1 multiplexer, 4-2 multiplexer, and so forth. The multiplexer unit 420 may further transmit the control signal to the fan motor controller 422 to control the fan 424.

FIG. 5 illustrates an exemplary flowchart 500 of a method for identifying control parameters for controlling the operation of the testing device 104, in accordance with an example embodiment of the present disclosure. FIG. 5 is explained in conjunction with elements from FIG. 1, FIG. 2, FIG. 3, FIG. 4A and FIG. 4B. The operations of the exemplary method may be executed by the system 102 of FIG. 1 or the processor 202 of FIG. 2. The operations of the flowchart 500 may start at 502.

At 502, the updated pressure data associated with the enclosure 108 and the flexible tubing 304 are continuously received. The updated pressure data may correspond to the pressure data 110C. In an embodiment, the system 102 may be configured to continuously receive updated pressure data associated with each of the flexible tubing 304 and the enclosure 108 from the pressure sensor(s) 210. The updated pressure data may correspond to real time pressure received at different time instants from the pressure sensor(s) when the testing device 104 is operating.

In an example, the system 102 may receive a first pressure value of pressure within the enclosure 108 at a first time instant. The first pressure value may be, for example, but not limited to, 70 Pascal (Pa). The system 102 may further receive a second pressure value of the pressure within the enclosure 108 at a second time instant as part of the updated pressure data. The second pressure value may be, for example, but not limited to, 100 Pa.

At 504, the updated pressure data is iteratively compared to the predefined target pressure value 110B. In an embodiment, the system 102 may be configured to compare the received first pressure value of the first time instant with the predefined target pressure value 110B. Similarly, the system 102 may be configured to compare the received second pressure value of the second time instant with the predefined target pressure value 110B. The predefined target pressure value 110B may correspond to maybe the pressure value needed to be maintained inside the enclosure 108 for performing the air leakage test and/or sealing operations.

At 506, a determination is made to ascertain whether the pressure within the enclosure 108 is greater than the predefined target pressure value 110B or not. To this end, the system 102 may continuously compare pressure values received at different time instants with the predefined target pressure value 110B for determining if the pressure within the enclosure 108 is greater than the predefined target pressure value 110B.

On determining the pressure value in the updated pressure data for a particular time instant to be greater than the predefined target pressure value 110B, the operation may move to 510, otherwise the operation may move to 508.

At 508, the second control signal is generated to cause an increase in the pressure within the enclosure 108. The system 102 may generate the second control signal when the pressure within the enclosure 108 is still less than the predefined target pressure value 110B. The second control signal may be transmitted to the controller 106 that further controls the testing device 104 to increase the pressure within the enclosure 104. The system 102 may control the parameters of the testing device 104 based on the generated second control signal to increase the pressure within the enclosure 108.

At 510, test data 110A associated with the enclosure 108 is obtained. Once the pressure within the enclosure 108 reaches the predefined target pressure value 110B, performing the air leakage test or the sealing operation may be initiated.

Subsequently, at 512, a third control signal is generated to reach and maintain the predefined target pressure value 110B within the enclosure 108 based on the test data 110A. In an embodiment, the system 102 may be configured to control, using the controller, the operation of the testing device 104 to maintain the predefined target pressure value 110B within the enclosure 108. The system 102 may generate the third control signal upon determination that the pressure value within the enclosure 108 is greater than the predefined target pressure value 110B. The third control signal is transmitted to the controller 106 for controlling the operations of the testing device 104. The controller 106 upon receiving the third control signal from the system 102 may control the testing device 104 to maintain the predefined pressure value 110B within the enclosure 108. The predefined target pressure value 110B needs to be maintained to ensure that the pressure value does not surpass a safe pressure value to further ensure the safety of the enclosure 108 and or its surroundings, as well as to ensure that the air leakage test and/or the sealing operation is performed accurately.

FIG. 6 illustrates an exemplary flowchart 600 of a method for controlling an operation of the testing device 104 for performing the air leakage test, in accordance with the present disclosure. FIG. 6 is explained in conjunction with FIG. 1, FIG. 2, FIG. 3, FIG. 4A, FIG. 4B, FIG. 5, and FIG. 6. The operations of the exemplary method may be executed by any computing system, for example, by the system 102 of FIG. 1 or the processor 202 of FIG. 2. The operations of the flowchart 600 may start at 602.

At 602, a first predefined control signal may be transmitted. In an embodiment, the system 102 may be configured to transmit the first predefined control signal to the testing device 104, specifically, the controller 106 of the testing device 104 to initiate the operation of the testing device 104.

At 604, a continual increase in volume of the fluid 402 flowing into the flexible tubing 304 is effected. In an embodiment, the system 102 may be configured to control the testing device 104, such as via the controller 106, to effect the continual increase in the volume of the fluid 402 flowing into the flexible tubing 304 until a termination condition is met. The termination condition may be associated with reaching an inflated state of the flexible tubing 304 from its deflated state. The testing device 104 is in fluid connection with the flexible tubing 304 thereby allowing flow of the fluid 402 from the testing device 104 to the flexible tubing 304.

At 606, pressure data is received. In an embodiment, the system 102 may be configured to receive the pressure data 110C associated with the flexible tubing 304 and the enclosure 108 from the pressure sensor(s) 210 when the inflated state of the flexible tubing 304 is reached. The enclosure 108 is in fluid connection with the flexible tubing 304. Subsequently, the fluid 402 may traverse from the testing device 104 to the enclosure 108 through the flexible tubing 304.

At 608, the pressure data and a predefined target pressure value are compared. In an embodiment, the system 102 may be configured to compare the pressure data 110C with the predefined target pressure value 110B to ascertain if a pressure within the enclosure 108 has reached or exceeded the predefined target pressure value 110B or not.

At 610, a second control signal is generated. In an embodiment, the system 102 may be configured to generate the second control signal for the controller 106 for controlling the operation of the testing device 104. The second control signal is generated based on the comparison. The second control signal is generated when the pressure data 110C is less than the predefined target pressure value 110B. Details associated with the generation of the second control signal are provided in conjunction with, for example, FIG. 1 and FIG. 5.

At 612, an increase of pressure within the enclosure 108 is caused. In an embodiment, the system 102 is configured to control the operation of the testing device 104 using the controller 106 to cause the increase in the pressure within the enclosure 108 to reach the predefined target pressure value 110B based on the second control signal.

Accordingly, blocks of the flowchart 600 support combinations of means for performing the specified functions and combinations of operations for performing the specified functions. It will also be understood that one or more blocks of the flowchart 600, and combinations of blocks in the flowchart 600, can be implemented by special-purpose hardware-based computer systems which perform the specified functions, or combinations of special-purpose hardware and computer instructions.

Alternatively, the system 102 may comprise means for performing each of the operations described above. In this regard, according to an example embodiment, examples of means for performing operations may comprise, for example, the processor and/or a device or circuit for executing instructions or executing an algorithm for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of reactants and/or functions, it should be appreciated that different combinations of reactants and/or functions may be provided by alternative embodiments without departing from the scope of the appended claims. In this regard, for example, different combinations of reactants and/or functions than those explicitly described above are also contemplated as may be set forth in some of the appended claims. Although specific terms are employed herein, they are used in a generic and descriptive sense only and not for purposes of limitation.

What is claimed is:

1. A system for controlling an operation of a testing device for performing an air leakage test, the system comprising:
a memory configured to store computer executable instructions; and
one or more processors configured to execute the instructions to:
transmit a first predefined control signal to the testing device to initiate the operation thereof;
in response to the first predefined control signal, cause the testing device to effect a continual increase in a volume of a fluid flowing into a flexible tubing until a termination condition is met, wherein the termination condition is associated with reaching an inflated state of the flexible tubing from a deflated state, and wherein the testing device is in fluid connection with the flexible tubing;
receive pressure data associated with each of the flexible tubing and an enclosure, wherein the pressure data is indicative of a pressure within each of the flexible tubing and the enclosure when the inflated state of the flexible tubing is reached, and wherein the enclosure is in fluid connection with the flexible tubing;
compare the received pressure data to a predefined target pressure value;
generate a second control signal for a controller for controlling the testing device based on the comparison; and
control, using the controller, the operation of the testing device to cause an increase in the pressure within the enclosure to reach the predefined target pressure value based on the second control signal.

2. The system of claim 1, wherein the one or more processors are further configured to:
continuously receive updated pressure data associated with each of the flexible tubing and the enclosure;
compare the received updated pressure data to the predefined target pressure value;
determine whether the pressure within at least the enclosure is greater than the predefined target pressure value; and
control, using the controller, the operation of the testing device to maintain the predefined target pressure value within the enclosure.

3. The system of claim 1, wherein the testing device is a fan operable to supply pressurized air to each of the flexible tubing and the enclosure.

4. The system of claim 3, wherein the one or more processors are further configured to:
control, using the controller, a rotation speed of the fan in response to the second control signal, wherein the rotation speed is controlled to reach and maintain the predefined target pressure value of the fluid within at least the enclosure.

5. The system of claim 1, wherein the one or more processors are further configured to:
calculate a pressure difference based on the comparison between the pressure data and the predefined target pressure value; and
generate the second control signal for the controller based on the pressure difference.

6. The system of claim 1, wherein the one or more processors are further configured to:
transmit, to the controller, the second control signal, wherein the controller is connected to the testing device; and
control, using the controller, the operation of the testing device to reach and maintain the predefined target pressure value of the fluid within at least the enclosure.

7. The system of claim 6, wherein the controller is at least one of: a proportional (P) controller, an integral (I) controller, a derivative (D) controller, a PI controller, a PD controller, a PID controller, a fuzzy logic controller, an on-off controller, an adaptive controller, a model predictive controller, or a sliding mode controller.

8. The system of claim 1, wherein the pressure data is received from one or more pressure sensors arranged in connection with each of the flexible tubing and the enclosure.

9. The system of claim 8, wherein the one or more pressure sensors comprises at least a manometer.

10. The system of claim 1, wherein the one or more processors are further configured to:
in response to controlling the operation of the testing device to maintain the predefined target pressure value within the enclosure, obtain test data associated with the enclosure, wherein the test data comprises at least one of: pressure characteristics data associated with the enclosure, flow characteristics data associated with the enclosure, or leakage characteristics data associated with the enclosure; and
generate a third control signal for the controller for controlling the testing device based on the test data.

11. The controller of claim 1, wherein the fluid comprises at least a portion of aerosolized sealant.

12. A method for controlling an operation of a testing device for performing an air leakage test, the method comprising:
transmitting a first predefined control signal to the testing device to initiate the operation thereof;
in response to the first predefined control signal, causing the testing device to effect a continual increase in a volume of a fluid flowing into the flexible tubing until a termination condition is met, wherein the termination condition is associated with reaching an inflated state of the flexible tubing from the deflated state, and wherein the testing device is in fluid connection with the flexible tubing;
receiving pressure data associated with each of the flexible tubing and the enclosure, wherein the pressure data is indicative of a pressure within each of the flexible tubing and the enclosure when the inflated state of the flexible tubing is reached, and wherein the enclosure is in fluid connection with the flexible tubing;
comparing the received pressure data to a predefined target pressure value;
generating a second control signal for a controller for controlling the testing device based on the comparison; and
controlling, using the controller, the operation of the testing device to cause an increase in the pressure within the enclosure to reach the predefined target pressure value based on the second control signal.

13. The method of claim 12, further comprising:
continuously receiving updated pressure data associated with each of the flexible tubing and the enclosure;
comparing the received updated pressure data to the predefined target pressure value;
determining whether the pressure within at least the enclosure is greater than the predefined target pressure value; and
controlling, using the controller, the operation of the testing device to maintain the pressure within the enclosure.

14. The method of claim 12, wherein the testing device is a fan operable to supply pressurized air to each of the flexible tubing and the enclosure.

15. The method of claim 14, further comprising:
controlling, using the controller, a rotation speed of the fan in response to the second control signal, wherein the rotation speed is controlled to reach and maintain the predefined target pressure value of the fluid within at least the enclosure.

16. The method of claim 12, further comprising:
calculating a pressure difference based on the comparison between the pressure data and the predefined target pressure value; and
generating the second control signal for the controller based on the pressure difference.

17. The method of claim 12, further comprising:
transmitting, to the controller, the second control signal, wherein the controller is connected to the testing device; and
controlling, using the control unit, the operation of the testing device to reach and maintain the predefined target pressure value of the fluid within at least the enclosure.

18. A computer programmable product comprising a non-transitory computer readable medium having stored thereon computer executable instructions for controlling an operation of a testing device for performing an air leakage test, which when executed by one or more processors, cause the one or more processors to carry out operations comprising:
transmitting a first predefined control signal to the testing device to initiate the operation thereof;
in response to the first predefined control signal, causing the testing device to effect a continual increase in a volume of a fluid flowing into the flexible tubing until a termination condition is met, wherein the termination condition is associated with reaching an inflated state of the flexible tubing from the deflated state, and wherein the testing device is in fluid connection with the flexible tubing;
receiving pressure data associated with each of the flexible tubing and the enclosure, wherein the pressure data is indicative of a pressure within each of the flexible tubing and the enclosure when the inflated state of the flexible tubing is reached, and wherein the enclosure is in fluid connection with the flexible tubing;
comparing the received pressure data to a predefined target pressure value;
generating a second control signal for a controller for controlling the testing device based on the comparison; and
controlling, using the controller, the operation of the testing device to cause an increase in the pressure within the enclosure to reach the predefined target pressure value based on the second control signal.

19. The computer programmable product of claim 18, wherein the operations further comprise:
continuously receiving updated pressure data associated with each of the flexible tubing and the enclosure;
comparing the received updated pressure data to the predefined target pressure value;
determining whether the pressure within at least the enclosure is greater than the predefined target pressure value; and
controlling, using the controller, the operation of the testing device to maintain the pressure within the enclosure.

20. The computer programmable product of claim 18, wherein the testing device is a fan operable to supply pressurized air to each of the flexible tubing and the enclosure, and wherein the operations further comprise:
controlling, using the controller, a rotation speed of the fan in response to the second control signal, wherein the rotation speed is controlled to reach and maintain the predefined target pressure value of the fluid within at least the enclosure.
